(19) United States
(12) Patent Application Publication
(10) Pub. No.: US 2004/0011720 A1
(43) Pub. Date: Jan. 22, 2004

(54) Light bodied fluid strain system

(76) Inventor: Ronald Lee Pampel, Tampa, FL (US)

Correspondence Address: Ronald L. Pampel, 6305 Lansdale Cr., Tampa, FL, 33616, US

(21) Appl. No.: 10/171,671

(22) Filed: Jun. 17, 2002

(51) Int. Cl. B01D 24/00

(52) U.S. Cl. 210/290

(57) ABSTRACT

001 Fluid enters (1) flow container through (2) inlet. Gravity forces fluid over porous stone, screen and smaller rock to break down impurities. Fluid exists through (A) outlet and (a2) compression seal.

002 Fluid through (3) uses gravity and flow to enter (4) lower second container from bottom through (C) Injection Ring.

003 Leveling fluid rises up through sand forcing out impurities. Screen and porous stone keep sand down.

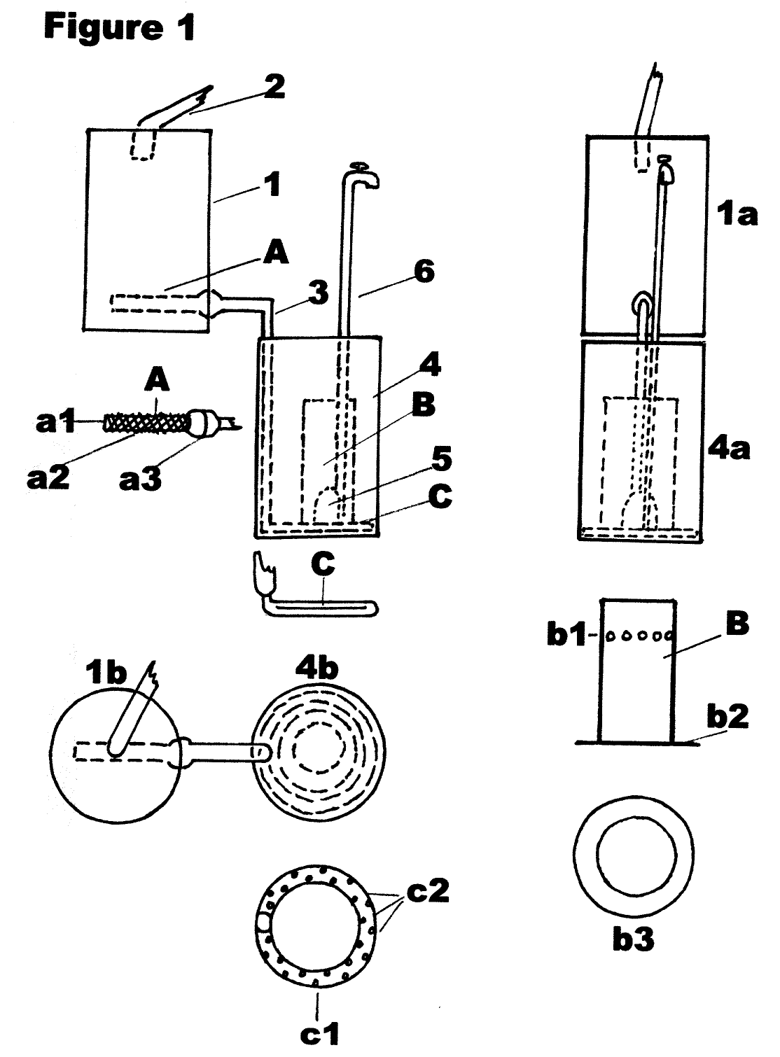

004 Fluid in FIG. 1 overflows into (B) Separation Cylinder for (5) sump pump to automatically pump out through (6) outlet.

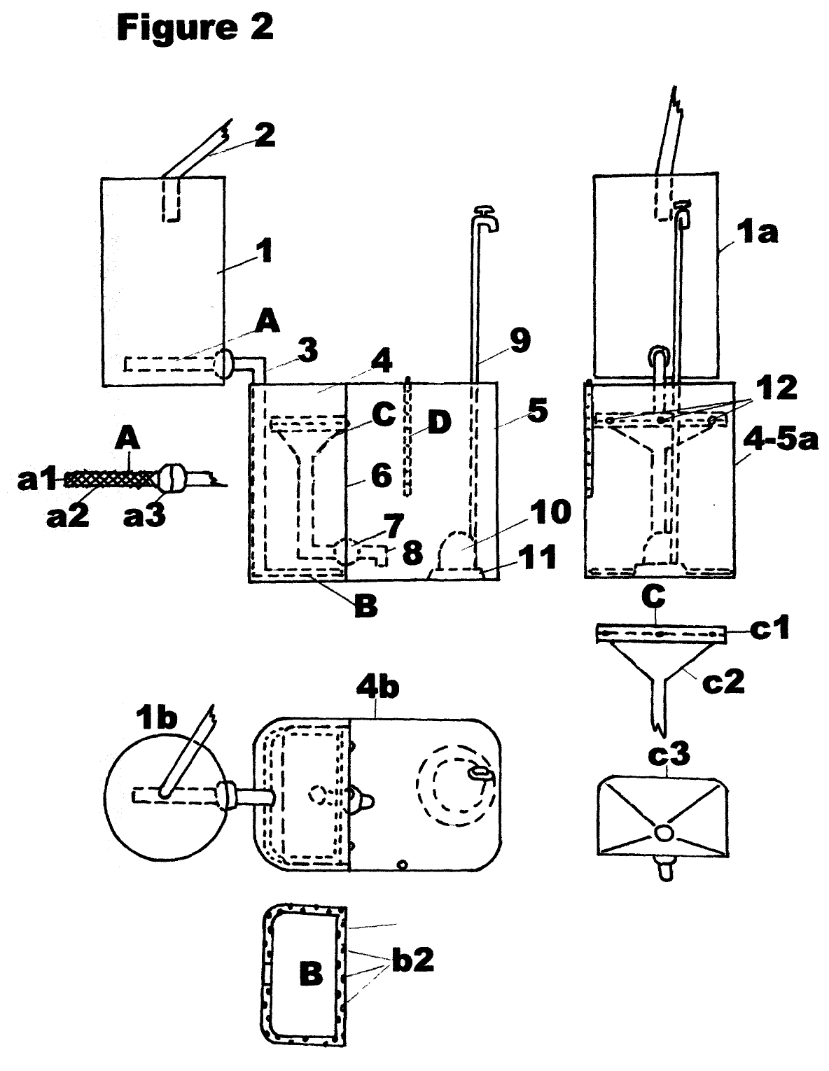

005 Fluid in FIG. 2, after flowing through process 001 to 003, overflows into its own (C) gathering funnel flowing into (7) pipe with compression seal and through

(6) separation wall to (5) holding tank. (D) The fluid gauge tells when the tank is full and an inner pump as in (10) or outer pump can be turned on.

This unit is a Light Bodied Fluid Strain System and is named as such. It is designed strictly to allow lighter bodied fluids to remain free flowing as to cause no resistance or back up to any other unit, which feeds it, whether automatic or hand held. The fluid is self transferred by its own properties of flow and leveling, while it is guided with pipes and walls of separation, through the graduation of layers of natural material. There are no moving parts to wear out, though a pump is added, whether inner or outer, only to remove already filtered fluids. And with all natural filtering materials, the remains of the filtered contaminants are left only to add to the abilities of the unit. While this unit requires virtually no maintenance, if ever the all-natural materials were to be replaced, the used materials remain useable, whether washed or as is.

### BACKGROUND

It has become evident that many fluids have consistently been turning up in short supply. While most of these can be filtered and reused, the processes have been complicated and generally use filters, which must be constantly changed and maintained. These filters were then discarded as they were not reusable.

### DRAWING

The drawings depict the units each as a whole, with blow-ups added of their own consecutive parts to enhance each description. Each separate part, whether working or connecting, is marked in increments which are referred to in ( ) in the description below.

No Other key is needed.

### DRAWING DESCRIPTION

FIG. 1

(1)—Flow container, using an upper layer of 10 lbs. of medium sized porous stone and a lower layer of 10 lbs. of smaller washed rock. With each layer separated by a fine mesh screen. (as in prototype; using a 32 gallon barrel made of ¼ inch plastic, but any strong, non-corrosive material will work)

(1a)—side view of flow container

(1b)—top view of flow container

(2)—2 inch diameter inlet pipe

(A)—First outlet

(a1)—2 inch diameter pipe with ¼ inch holes, drilled every square inch

(a2)—fine mesh, aluminum screen wrap

(a3)—compression nut and seal

(3)—second 2 inch diameter inlet pipe

(4)—Lower secondary container, using an upper layer of 5 lbs. of medium sized porous stone and a lower layer of 15 lbs. of silicate sand. With each layer separated by a fine mesh screen. (as in prototype; using a 32 gallon barrel made of ¼ inch plastic, but any strong, non-corrosive material will work)

(4a)—side view of lower secondary container

(4b)—top view of lower secondary container

(B)—Separation Cylinder, 12 inches in diameter (used mainly in smaller system w/o holding tank)

(b1)—⅜ inch holes drilled 3 inches below top edge

(b2)—18 inch diameter base

(b3)—top view of Separation Cylinder

(5)—Submersible fluid pump (as in prototype; set on automatic)

(6)—1 inch diameter final outlet with faucet

(C)—Side view of 18 inch Inlet Ring, of 1 inch diameter pipe

(c1)—bottom view of Inlet Ring

(c2)—⅛ inch holes drilled every ½ inch staggered along bottom

### DRAWING DESCRIPTION

FIG. 2

(1)—Flow container, using an upper layer of 10 lbs. of medium sized porous stone and a lower layer of 10 lbs. of smaller washed rock. With each layer is separated by a fine mesh aluminum screen. (as in prototype; using a 32 gallon barrel made of ¼ inch plastic, but any strong, non-corrosive material will work)

(1a)—side view of flow container

(1b)—top view of flow container

(2)—2 inch diameter inlet pipe

(A)—First outlet

(a1)—2 inch pipe with ¼ inch holes drilled every square inch

(a2)—fine mesh aluminum screen wrap

(a3)—compression nut and seal

(3)—second 2 inch diameter inlet pipe

(4)—First section of secondary container, using an upper layer of 5 lbs. of medium sized porous stone and a lower layer of 15 lbs. silicate sand. With each layer separated by a fine mesh aluminum screen. (as in prototype; using a 100 gallon oval container made of ⅜ inch fiberglass, with a solid wall separating the first section of 30 of gallons from the second section of 70 gallons, but any strong, non-corrosive material will work)

(4-5a)—side view of secondary container from side of holding tank

(4b)—top view of secondary container

(B)—Injection ring

(b1)—bottom view of injection ring

(b2)—⅛ inch holes staggered every 1 inch along bottom

(C)—Gathering funnel

(c1)—2 inch wide strip set at the lip of the funnel to provide 1 inch of protection above lip and 1 inch below

(c2)—funnel dimensions set to fit within 1 inch of front and back of the first section of the second container, 3 inches of the inlet side wall, mounted to the solid separation wall and connecting down to 2 inch outlet pipe

(c3)—top view of funnel (as in prototype)

(5)—Final section of secondary container. Mainly a holding cell with a submersible pump and fluid gauge, which can be pumped out either manually or set on automatic.

(6)—Solid separation wall with sealed holes drilled for gathering funnel mount and lower 2 inch inlet pipe.

(7)—Compression nut and seal.

(8)—third 2 inch inlet pipe.

(9)—1 inch outlet pipe from submersible pump. (as in prototype; with faucet)

(D)—Fluid measurement gauge for amount contained in holding tank.

(10)—Submersible pump.

(11)—Base riser made to fit size of pump base. (as in prototype; 3 inches high)

(12)—Mount bolts, made of non-corrosive material.

1) This system uses no paper filter, which would need replacing but instead a combination of all natural rock and sand. And being a free flow system, there are no moving parts to wear out, except the added pump.

2) The use of all natural filtering materials, with gravity and the lighter bodied fluids own properties of leveling and flow keeps this system from having any kind of constant maintenance, while it takes away impurities and adds none. When used properly, no waste material is caused by using this system.

3) The use of the Inlet Injection Ring guarantees an even flow through the final filtering materials.

4) The use of the Separation Cylinder, as in FIG. 1, saves wear and tear on the submersible pump, while allowing for a smaller containment area.

5) Not using air tight lids on either lower container allows for easy access while air is also allowed in and out to compensate for fluid level. Also in case of area flooding, an air pocket is not left to cause the entire container to float. No containment is held under pressure

6) This method of reclaiming lighter bodied fluids is designed to save 100's of gallons per week, per user.
